(19) United States
(12) Patent Application Publication
(10) Pub. No.: US 2012/0269306 A1
(43) Pub. Date: Oct. 25, 2012

(54) METHOD AND APPARATUS FOR CROSS-POLARIZATION COMPENSATION

(75) Inventor: Thomas A. Schonhoff, Shrewsbury, MA (US)

(73) Assignee: RAYTHEON COMPANY, Waltham, MA (US)

(21) Appl. No.: 13/092,569

(22) Filed: Apr. 22, 2011

(51) Int. Cl. H04B 1/12

(52) U.S. Cl. 375/349

(57) ABSTRACT

Methods and apparatus for compensating for polarization loss in communications systems that use orthogonally spaced polarization. In one example, a signal processing method uses a statistical decorrelation process to separate out two orthogonally polarized desired signals from noisy received signals that include these orthogonally polarized desired signals along with their cross-polarized components, thereby compensating for the polarization contamination.

### BACKGROUND

In many satellite communication systems, there is an increasing need for more data to be transmitted over a limited bandwidth downlink channel. One technique for maximizing bandwidth utilization includes transmitting half the data at one polarization and the other half at an orthogonal polarization, thereby effectively doubling the downlink data rate in the same bandwidth. Although it is possible to achieve orthogonal polarizations on the two data streams at the satellite transmitter, as the signal progresses through the atmosphere, the effects of atmospheric molecules often partially depolarize the signal, causing considerable cross-contamination of each signal data stream by the other. This contamination causes a loss in performance. Such performance loss is generally included in the downlink link budget without any attempt to address or solve the contamination problem. For example, a specification is generally set for the acceptable loss in the system, and the transmitter is configured to meet this specification. This can result in expensive transmitter components.

### SUMMARY OF INVENTION

Aspects and embodiments are directed to a cheaper and more effective approach than simply accounting for loss in the link budget, as discussed above, that uses statistical decorrelation to process the received signals and compensate for cross-polarization contamination.

According to one embodiment, a digital signal processor-implemented method of compensating for cross-polarization in a communications system comprises acts of receiving at a receiver of the communications system a first input signal comprising a first transmitted signal and a first cross-polarization component of a second, orthogonally polarized transmitted signal, receiving at the receiver a second input signal comprising the second, orthogonally polarized transmitted signal and a second cross-polarization component of the first transmitted signal, calculating a two-by-two cross-correlation matrix for the first and second input signals, calculating a corresponding decorrelation matrix, and performing a matrix multiplication of the decorrelation matrix with a first vector comprising the first and second input signals to generate a second vector comprising first and second output signals. The first output signal is representative of the first transmitted signal and the second output signal is representative of the second, orthogonally polarized transmitted signal, the first and second output signals being substantially free of the first and second cross-polarization components.

In one example, the method further comprises demodulating the first and second output signals to obtain data carried in the first and second transmitted signals, respectively. In another example of the method, calculating the decorrelation matrix includes calculating a first matrix whose columns comprise complex eigenvectors of the cross-correlation matrix, and obtaining the complex conjugate of the first matrix to provide the decorrelation matrix. The method may further comprise sampling the first and second input signals to provide a plurality of complex samples of each of the first and second input signals. In one example, calculating the two-by-two cross-correlation matrix includes calculating the two-by-two cross-correlation matrix based on the plurality of complex samples of each of the first and second input signals, wherein a first term in the cross-correlation matrix represents energy in the first input signal over the plurality of complex samples of the first input signal, wherein a second, diagonal term of the cross-correlation matrix represents energy in the second input signal over the plurality of complex samples of the second input signal, and wherein the remaining two terms of the cross-correlation matrix represent cross-correlation between the first and second input signals. The method may further comprise storing the plurality of complex samples in a digital storage medium in the receiver during the acts of calculating the two-by-two cross-correlation matrix for the first and second input signals, and calculating the corresponding decorrelation matrix. In another example, performing the matrix multiplication of the decorrelation matrix with the first vector including performing the matrix multiplication of the decorrelation matrix with the first vector which comprises the plurality of complex samples of each of the first and second input signals.

According to another embodiment, a communications system receiver comprises a first input configured to receive a first signal including a first transmitted signal having a first polarization and a first cross-polarization component of a second transmitted signal having a second, orthogonal polarization, a second input configured to receive a second signal including the second transmitted signal and a second cross-polarization component of the first transmitted signal, and a digital signal processor configured to receive the first and second signals, the digital signal processor configured to implement a statistical decorrelation separation process separate the first and second transmitted signals from the first and second signals and to provide first and second output signals, the first and second output signals corresponding to the first and second transmitted signals, respectively, and being substantially free of the first and second cross-polarization components.

In one example, the communications system receiver further comprises a demodulator configured to demodulate the first and second signals. In another example, the digital signal processor is configured to implement the statistical decorrelation separation process comprising steps of: calculating a two-by-two cross-correlation matrix for the first and second signals, calculating a corresponding decorrelation matrix, and performing a matrix multiplication of the decorrelation matrix with a first vector comprising the first and second signals to generate a second vector comprising first and second output signals, wherein the first output signal corresponds to the first transmitted signal and the second output signal corresponds to the second transmitted signal. The communications system receiver may further comprise a complex sampler configured to take a plurality of complex samples of each of the first and second signals and to provide the plurality of complex samples to the digital signal processor. The communications system receiver may also comprise a digital storage medium configured to store the plurality of complex samples. In one example, the communications system receiver further comprises a down-converter coupled between the first and second inputs and the complex sampler, and configured to down-convert a carrier frequency of the first and second signals to a processing frequency, the processing frequency being lower than the carrier frequency. In another example, the communications system receiver further comprises an antenna including a first antenna element coupled to the first input and configured to receive the first signal and provide the first signal to the first input, and a second antenna element coupled to the second input and configured to provide the second signal to the second input. The communications system receiver may be, for example, a satellite communications system receiver or other wireless communications system receiver.

Another embodiment is directed to a method of compensating for cross-polarization in a communications receiver configured for dual-polarized signaling. The method comprises receiving at the receiver a first input signal including a first carrier signal having a first polarization and modulated with a first data stream, and a first cross-polarization component of a second carrier signal having a second, orthogonal polarization, receiving at the receiver a second input signal including the second carrier signal modulated with a second data stream, and a second cross-polarization component of the first carrier signal, performing a statistical decorrelation separation process to separate the first and second carrier signals from the first and second input signals, and based on the statistical decorrelation separation process, providing first and second output signals corresponding to the first and second transmitted signals, respectively, and being substantially free of the first and second cross-polarization components.

In one example, the method further comprises demodulating the first output signal to obtain the first data stream, and demodulating the second output signal to obtain the second data stream. In another example, performing the statistical decorrelation process includes calculating a two-by-two cross-correlation matrix for the first and second input signals, calculating a corresponding decorrelation matrix, and performing a matrix multiplication of the decorrelation matrix with a first vector comprising the first and second input signals to generate a second vector comprising the first and second output signals. Calculating the decorrelation matrix may include, for example, calculating a first matrix whose columns comprise complex eigenvectors of the cross-correlation matrix, and obtaining the complex conjugate of the first matrix to provide the decorrelation matrix. In one example, the method further comprises sampling the first and second input signals to provide a plurality of complex samples of each of the first and second input signals.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a simplified functional block diagram for receiving dual polarized signals;

FIG. 2 is a functional block diagram of one example of a receiver according to aspects of the invention; and

FIG. 3 is a statistical decorrelation separation process according to aspects of the invention.

### DETAILED DESCRIPTION

Cross-polarization compensation techniques have been studied for decades and some have been implemented in line-of-sight microwave relay systems in commercial systems; however, the complexity of known techniques has generally precluded their use in satellite communications systems. Aspects and embodiments discussed herein are directed to methods and apparatus for compensating for polarization loss in communications systems that use orthogonally spaced polarization, including a signal processing method that offers a considerable improvement in polarization contamination compensation at affordable costs. In one embodiment, a statistical decorrelation process is used to separate out two orthogonally polarized desired signals from noisy received signals that include these orthogonally polarized desired signals along with their cross-polarized components, thereby compensating for the polarization contamination. This compensation may provide significant benefits, including allowing receivers to receive more data at higher reliability and lower costs in communication applications.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

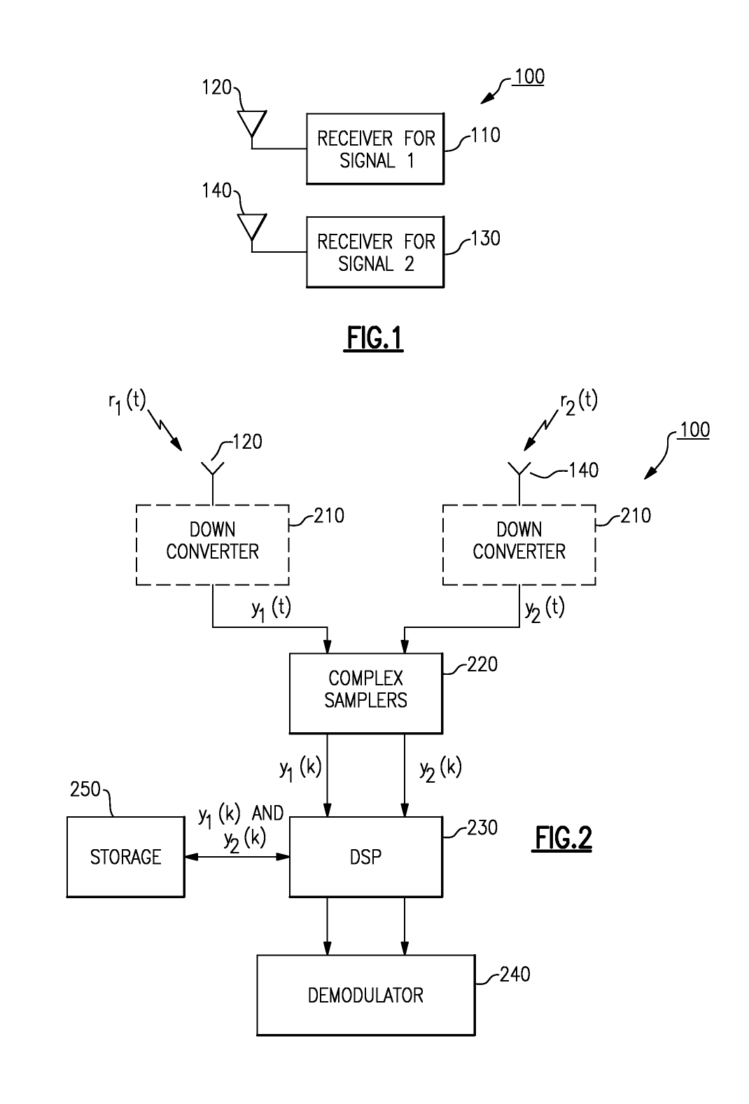

Referring to FIG. 1 there is illustrated a simplified functional block diagram of a dual-polarized receiver system, for example, a satellite receiver. The receiver system 100 includes a first receiver chain/path 110 for receiving a first signal data stream coupled to a first antenna 120 at a first polarization, and a second receiver chain 130 for receiving a second signal data stream coupled to a second antenna 140 at a second, orthogonal polarization. In the case of perfect orthogonal polarization, the input to the first receiver 110 can be modeled as:

r₁(t)=A₁ cos(2πf_{c}t+\vec{d}₁(t)+φ₁)+z₁(t) (1)

Similarly, the input to the second receiver 130 can be modeled as:

r₂(t)=A₂ cos(2πf_{c}t+\vec{d}₂(t)+φ₁)+z₂(t) (2)

In Equations (1) and (2), f_{c} is the carrier frequency; A₁ and A₂ are the amplitudes of the two signals; \vec{d}₁(t) and \vec{d}₂ (t) are the complex data streams, assumed to be uncorrelated, on the first and second signals, respectively; φ₁ and φ₂ are the starting phases on each of the received signals; and z₁(t) and z₂ (t) are complex noise signals on each of the received signals, assumed to be independent. The two received signals do not have to be at the same amplitude (i.e., A₁ and A₂ may be different) or power, but in practice they may often be the same. No assumptions are made regarding the relationship, or lack thereof, of the two starting phases φ₁ and φ₂ to one another. In one embodiment, the complex data streams \vec{d}₁(t) and \vec{d}₂ (t) are implemented by applying a modulation scheme to the carrier signals, for example, phase shift keying, frequency shift keying, or a combination of both.

In the hypothetical scenario of perfect orthogonal polarization, each receiver chain 110, 130 processes its received signal, r₁(t) and r₂(t), respectively, and there is no degradation of either received signal by the other signal. However, under practical or more realistic circumstances where the received signals have suffered some depolarization through the downlink, the inputs to the first receiver chain 110 is given by:

y₁(t)=b₁₁r₁(t)+b₂₁r₂(t) (3)

Similarly, the input to the second receiver 130 is give by:

y₂(t)=b₁₂r₁(t)+b₂₂r₂(t) (4)

In Equations (3) and (4), the parameters b₁₁, b₁₂, b₂₁, and b₂₂ are terms that correspond to the relative amplitudes and phases (that is, they are complex parameters) of the constituent signals r₁(t) and r₂(t). Aspects and embodiments are directed to a signal processing scheme that “separates” the original orthogonally polarized signals r₁(t) and r₂(t) from the received signals y₁(t) and y₂(t), to remove the cross-polarized components, as discussed further below.

According to one embodiment, the receiver 100 is configured to implement a signal processing method that uses statistical decorrelation to separate the original signals r₁(t) and r₂ (t) from the received signals y₁(t) and y₂(t) and thereby compensate for the effects of cross-polarization in the downlink. In one example, the method is based on creating a two-by-two cross-correlation matrix for the two input signals to the receiver and, using eigentheory to develop a corresponding decorrelation matrix, processing the matrices to obtain representations of the original signals r₁(t) and r₂(t), as discussed in detail below. Similar methods have been used to process orthogonally oriented antennas receiving different signals and noise from different directions, and to process downlink signals in adjacent frequency bands in a densely packed downlink spectrum; however, application of the method to cross-polarization compensation is unique.

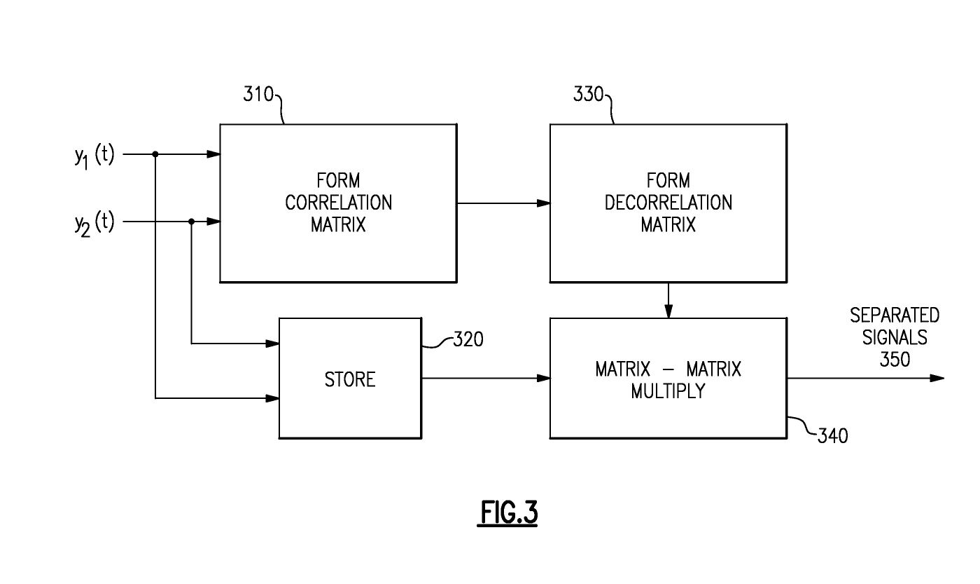

Referring to FIG. 2, there is illustrated a functional block diagram of one embodiment of the communications receiver 100. As discussed above, the two orthogonally polarized signals are received by the antennas 120 and 140. The signals may optionally be down-converted from the carrier frequency to a lower, intermediate frequency by down-converters 210. It is to be appreciated that although FIG. 2 illustrates a down-converter 210 coupled to each antenna 120, 140, down-conversion may be implemented by a common down-converter coupled to both antennas. Those skilled in the art will further appreciate that additional analog processing (not shown), for example, low noise filtering, may also be performed on the signals y₁(t) and y₂(t) before or after the down-conversion process.

Embodiments of the signal processing method for cross-polarization compensation discussed herein may primarily be implemented, and therefore discussed below, in terms of digital signal processing. Accordingly, the time-varying signals y₁(t) and y₂(t) may be sampled by complex samplers 220 which generate complex samples y₁(k) and y₂(k) of the signals y₁(t) and y₂(t), respectively, as discussed further below. These complex samples are provided to a digital signal processor 230 configured to implement a statistical decorrelation process, as discussed below, to obtain signals representative of each of the orthogonally polarized received signals r₁(t) and r₂(t) individually. Additionally, the complex samples yᵢ(k) may be stored in storage 250 while the signal processing is performed. The signals obtained from the statistical decorrelation process may then be processed to extract the data carried in r₁(t) and r₂(t), for example, the signals may be demodulated by demodulator 240, along with any other required processing, as would be understood by those skilled in the art.

According to a variety of examples, the digital signal processor 230 is a commercially available processor such as processors manufactured by Texas Instruments, Intel, AMD, Sun, IBM, Motorola, Freescale and ARM Holdings. However, the digital signal processor 230 may be any type of processor, field-programmable gate array, multiprocessor or controller, whether commercially available or specially manufactured. In some examples, the storage 250 includes a relatively high performance, volatile, random access memory such as dynamic random access memory (DRAM), static memory (SRAM) or synchronous DRAM. However, the storage 250 may include any device for storing data, such as a non-volatile memory, with sufficient throughput and storage capacity to support the functions described herein. In some examples, the storage 250 may include hardware or software configured to enable concurrent access to stored data, including the stored complex samples.

Referring to FIG. 3, there is illustrated a functional block/flow diagram of a statistical decorrelation separation process that may be implemented by the receiver 100 according to one embodiment. In step 310 a two-by-two correlation matrix is formed based on the two receiver input signals y₁(t) and y₂(t). Based on Equations (3) and (4) above, y(t) can be defined as a matrix comprising elements yᵢ(t) given by:

$${y}_{i} ( t ) = {\sum }_{j = 1}^{2} {b}_{ij} {r}_{j} ( t ) \qquad ( 5 )$$

Thus, y(t)=Br(t), where B is the two-by-two matrix B=[bᵢⱼ] that comprises the parameters b₁₁, b₁₂, b₂₁, and b₂₂ from above. By definition, the cross-correlation matrix, R=[rᵢⱼ], is given by:

R=y(t)y*(t) (5)

In Equation (5), and hereinafter, the asterisk (*) indicates the complex conjugate. Substituting for y(t) in Equation (5), it follows that:

R=R*=[Br(t)][Br(t)]*=Br(t)r*(t)B* (6)

Thus, R is shown to be directly related to r(t), and since r₁(t) and r₂(t) are assumed to be uncorrelated, r(t)r*(t) is a diagonal matrix.

As discussed above, the signals r₁(t) and r₂(t), and therefore y₁(t) and y₂ (t), are time-varying signals. Accordingly, consider taking K complex samples of the input signals y₁(t) and y₂(t), represented by yᵢ(k), where i=1, 2 and k=1, K. Thus, the signals y₁(t) and y₂(t) can be approximated by:

$${y}_{i} ( t ) = {\sum }_{k - 1}^{K} {y}_{i} ( k ) \qquad ( 7 )$$

Then, the two-by-two cross-correlation matrix R is given by:

$$R = [ \begin{matrix}{\sum }_{k = 1}^{K} {y}_{1} ( k ) {y}_{1}^{*} ( k ) & {\sum }_{k = 1}^{K} {y}_{1} ( k ) {y}_{2}^{*} ( k ) \\ {\sum }_{k = 1}^{K} {y}_{2} ( k ) {y}_{1}^{*} ( k ) & {\sum }_{k = 1}^{K} {y}_{2} ( k ) {y}_{2}^{*} ( k )\end{matrix} ] \qquad ( 8 )$$

In Equation (8), the top-left component represents the energy in the signal y₁(t) over the K samples, and the bottom-right component represents the energy in the signal y₂(t) over the K samples. The other two terms indicate the cross-correlation between the two signals. The value of K, i.e., the number of samples taken, is open to a system designer's choice, and may be selected based on various factors, including, for example, processing time, the rate of variation of the time-varying signals r₁(t) and r₂(t), etc.

Referring again to FIGS. 2 and 3, in step 320 the K complex samples of y₁(t) and y₂(t) are stored while the other computations are completed. For example, as discussed above, the complex samples yᵢ(k) may be stored in the storage device 250, e.g., a memory or other computer-readable storage device, that is coupled to or is part of the digital signal processor 230, as illustrated in FIG. 2. Step 330 includes forming a decorrelation matrix that will be used to separate the signals and remove or reduce the cross-polarization contamination. The cross-correlation matrix R can be shown to be a positive-definite matrix, and as such can be written as the product of three matrices:

R=EΛE*^{T} (9)

In Equation (9), A is a diagonal matrix of the eigenvalues of R, and the columns of E are orthogonal eigenvectors of R. E*^{T} is the complex transpose of E and is equal to the inverse of E, that is, E*^{T}=E⁻¹. These three matrices can be found using conventional numerical techniques.

Still referring to FIG. 3, step 340 includes performing matrix multiplication computations to achieve the signal separation. According to one embodiment, a vector comprising components xᵢ(k) is defined by multiplying the complex samples yᵢ(k) by the complex conjugate of the decorrelation matrix E:

x(k)=E*y(k) (10)

This linear transformation produces a two-by-K matrix with components xᵢ(k), where i=1, 2 and k=1, K. Then,

x(k)x*(k)=E*y(k)[E*y(k)]*=E*y(k)y*(k)E (11)

Based on the definition of R given in Equations (5), and on Equations (7) and (9) above, Equation (11) can be rewritten:

x(k)x*(k)=E*RE=Λ (12)

Thus, the component x₁ (k) is uncorrelated from x₂(k), since Λ is a diagonal matrix, and each has a power that is approximately equal to one half of the corresponding eigenvalue of R. For this reason, based on Equations (6) and (9), each component x₁(k) and x₂(k) is shown to be composed primarily of one of the input signals r₁(t) and r₂(t). Thus, by performing the matrix computations of steps 310, 330 and 340, representations 350 of the original, orthogonally polarized signals r₁(t) and r₂(t), essentially uncontaminated by cross-polarization, can be obtained.

As discussed above, and referring again to FIG. 2, these “separated” signals x₁(k) and x₂(k) can be processed by circuitry in the receiver 100, including for example, demodulated by demodulator 240, to extract the complex data streams and information they represent. Simulations of signals carrying known data have demonstrated that processing the constructed signals x₁(k) and x₂(k) yields very close agreement with the original data carried in r₁(t) and r₂(t). Thus, embodiments of the statistical decorrelation process may be used to achieve significant improvement in communications systems performance by compensating for the effects of cross-polarization. The method is relatively simple and easy to implement in a satellite communications system receiver. Similarly, embodiments of the statistical decorrelation process may be implemented in receivers of other types of communications systems that use dual-polarized signaling to compensate for cross-polarization contamination. In addition, the process is self-adapting to changing downlink conditions and independent of specific downlink signals. Embodiments of the method may be very robust in separating out cross-polarized signals into their constituent components, thus allowing each component to be demodulated, decoded and processed in conventional manners.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A digital signal processor-implemented method of compensating for cross-polarization in a communications system, the method comprising:
receiving at a receiver of the communications system a first input signal comprising a first transmitted signal and a first cross-polarization component of a second, orthogonally polarized transmitted signal;
receiving at the receiver a second input signal comprising the second, orthogonally polarized transmitted signal and a second cross-polarization component of the first transmitted signal;
calculating a two-by-two cross-correlation matrix for the first and second input signals;
calculating a corresponding decorrelation matrix; and
performing a matrix multiplication of the decorrelation matrix with a first vector comprising the first and second input signals to generate a second vector comprising first and second output signals, wherein the first output signal is representative of the first transmitted signal and the second output signal is representative of the second, orthogonally polarized transmitted signal, the first and second output signals being substantially free of the first and second cross-polarization components.

2. The method as claimed in claim 1, further comprising:
demodulating the first and second output signals to obtain data carried in the first and second transmitted signals, respectively.

3. The method as claimed in claim 1, wherein calculating the decorrelation matrix includes:
calculating a first matrix whose columns comprise complex eigenvectors of the cross-correlation matrix; and
obtaining the complex conjugate of the first matrix to provide the decorrelation matrix.

4. The method as claimed in claim 1, further comprising sampling the first and second input signals to provide a plurality of complex samples of each of the first and second input signals.

5. The method as claimed in claim 4, wherein calculating the two-by-two cross-correlation matrix includes calculating the two-by-two cross-correlation matrix based on the plurality of complex samples of each of the first and second input signals;
wherein a first term in the cross-correlation matrix represents energy in the first input signal over the plurality of complex samples of the first input signal;
wherein a second, diagonal term of the cross-correlation matrix represents energy in the second input signal over the plurality of complex samples of the second input signal; and
wherein the remaining two terms of the cross-correlation matrix represent cross-correlation between the first and second input signals.

6. The method as claimed in claim 4, further comprising storing the plurality of complex samples in a digital storage medium in the receiver during the acts of calculating the two-by-two cross-correlation matrix for the first and second input signals, and calculating the corresponding decorrelation matrix.

7. The method as claimed in claim 6, wherein performing the matrix multiplication of the decorrelation matrix with the first vector including performing the matrix multiplication of the decorrelation matrix with the first vector which comprises the plurality of complex samples of each of the first and second input signals.

8. A communications system receiver comprising:
a first input configured to receive a first signal including a first transmitted signal having a first polarization and a first cross-polarization component of a second transmitted signal having a second, orthogonal polarization;
a second input configured to receive a second signal including the second transmitted signal and a second cross-polarization component of the first transmitted signal;
a digital signal processor configured to receive the first and second signals, the digital signal processor configured to implement a statistical decorrelation separation process separate the first and second transmitted signals from the first and second signals and to provide first and second output signals, the first and second output signals corresponding to the first and second transmitted signals, respectively, and being substantially free of the first and second cross-polarization components.

9. The communications system receiver as claimed in claim 8, further comprising a demodulator configured to demodulate the first and second signals.

10. The communications system receiver as claimed in claim 8, wherein the digital signal processor is configured to implement the statistical decorrelation separation process comprising steps of:
calculating a two-by-two cross-correlation matrix for the first and second signals;
calculating a corresponding decorrelation matrix; and
performing a matrix multiplication of the decorrelation matrix with a first vector comprising the first and second signals to generate a second vector comprising first and second output signals, wherein the first output signal corresponds to the first transmitted signal and the second output signal corresponds to the second transmitted signal.

11. The communications system receiver as claimed in claim 10, further comprising a complex sampler configured to take a plurality of complex samples of each of the first and second signals and to provide the plurality of complex samples to the digital signal processor.

12. The communications system receiver as claimed in 11, further comprising a digital storage medium configured to store the plurality of complex samples.

13. The communications system receiver as claimed in claim 11, further comprising a down-converter coupled between the first and second inputs and the complex sampler, and configured to down-convert a carrier frequency of the first and second signals to a processing frequency, the processing frequency being lower than the carrier frequency.

14. The communications system receiver as claimed in 8, further comprising an antenna including a first antenna element coupled to the first input and configured to receive the first signal and provide the first signal to the first input, and a second antenna element coupled to the second input and configured to provide the second signal to the second input.

15. The communications system receiver as claimed in claim 8, wherein the receiver is a satellite communications system receiver.

16. A method of compensating for cross-polarization in a communications receiver configured for dual-polarized signaling, the method comprising:
receiving at the receiver a first input signal including a first carrier signal having a first polarization and modulated with a first data stream, and a first cross-polarization component of a second carrier signal having a second, orthogonal polarization;
receiving at the receiver a second input signal including the second carrier signal modulated with a second data stream, and a second cross-polarization component of the first carrier signal;
performing a statistical decorrelation separation process to separate the first and second carrier signals from the first and second input signals;
based on the statistical decorrelation separation process, providing first and second output signals corresponding to the first and second transmitted signals, respectively, and being substantially free of the first and second cross-polarization components.

17. The method as claimed in claim 16, further comprising:
demodulating the first output signal to obtain the first data stream; and
demodulating the second output signal to obtain the second data stream.

18. The method as claimed in claim 16, wherein performing the statistical decorrelation process includes:
calculating a two-by-two cross-correlation matrix for the first and second input signals;
calculating a corresponding decorrelation matrix; and
performing a matrix multiplication of the decorrelation matrix with a first vector comprising the first and second input signals to generate a second vector comprising the first and second output signals.

19. The method as claimed in claim 18, wherein calculating the decorrelation matrix includes:
calculating a first matrix whose columns comprise complex eigenvectors of the cross-correlation matrix; and
obtaining the complex conjugate of the first matrix to provide the decorrelation matrix.

20. The method as claimed in claim 16, further comprising sampling the first and second input signals to provide a plurality of complex samples of each of the first and second input signals.
